(19) United States
(12) Patent Application Publication
(10) Pub. No.: US 2003/0164413 A1
(43) Pub. Date: Sep. 4, 2003

(54) Gadget for washing mixing containers

(76) Inventor: Klaus Schaefer, Wuppertal (DE)

Correspondence Address: JORDAN AND HAMBURG LLP, 122 EAST 42ND STREET, SUITE 4000, NEW YORK, NY, 10168, US

(21) Appl. No.: 10/300,604

(22) Filed: Nov. 20, 2002

(30) Foreign Application Priority Data
Nov. 25, 2001 (DE) 201 19 146.6

(51) Int. Cl. B08B 3/00

(52) U.S. Cl. 239/553.5; 134/171; 134/198

(57) ABSTRACT

Rinsing equipment, especially for mixing containers, including a socket housing with an interior pressure rinsing valve and an upright vatve tube, wherein a spraying plate is seated on this valve tube. The spraying plate may have a trough-shaped depression or run out into star-shaped guiding cross members. The spraying equipment may include several upwardly or horizontally directed nozzles. The spraying plate may also include a water distribution chamber.

In the area of gastronomy, rinsing equipment or dish-washing machines are usually used to clean containers, especially for drinking glasses, pitchers and the like.

Because of the lip contact, which has taken place, and the encrusted beverage residues, thorough cleaning or also disinfecting is of primary importance in a first step here and rinsing in a subsequent second step is of lesser importance.

Drinking vessels have a smooth, rounded inner contour, with which good cleaning results can be achieved. They are therefore cleaned with brushes or with hot water.

Known solutions for this are found, for example, in the German patent P 31 31 333.7 and in the U.S. Pat. No. 4,422,466 or in the German utility patent 299 10 403.6 or in the European PCT/EP 00/04706.

On the other hand, there is no lip contact in the case of mixing containers and the cleaning step is therefore of no importance, whereas the rinsing is important and, at the same time, difficult because of the complicated, tiered inner contour of these containers.

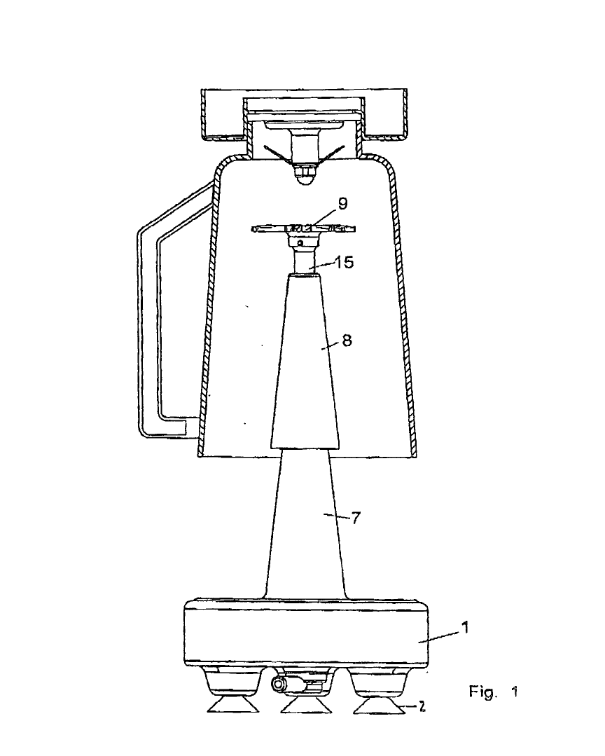

Different mixed drinks are prepared alternately in these mixing containers, which must be rinsed intensively, in order to avoid affecting the taste. The problem of rinsing arises out of the special contour of the mixing containers; for example, the bottom has a tiered chamber, in which the impact knives for communicating ice and pieces of fruit rotate (FIG. 1). For this reason, this chamber is practically inaccessible to brushes like those, used in known glass rinsing equipment.

The invention therefore is based on the need for thoroughly rinsing mixing containers with a difficult, tiered inner contour.

This objective is accomplished pursuant to the invention by the rinsing equipment, which is placed under protection in claim 1 as well as in the dependent claims 2 to 6. The objective is also accomplished by the spraying plate, placed under protection in claim 7 as well as in the dependent claims 8 to 11.

The invention is explained in greater detail by means of an advantageous embodiment and the FIGS. 1 to 4 enclosed, of which

FIG. 1 shows a view of the rinsing equipment, over which the mixing container is inverted (section), the impact knife chamber of the mixing container being well recognizable,

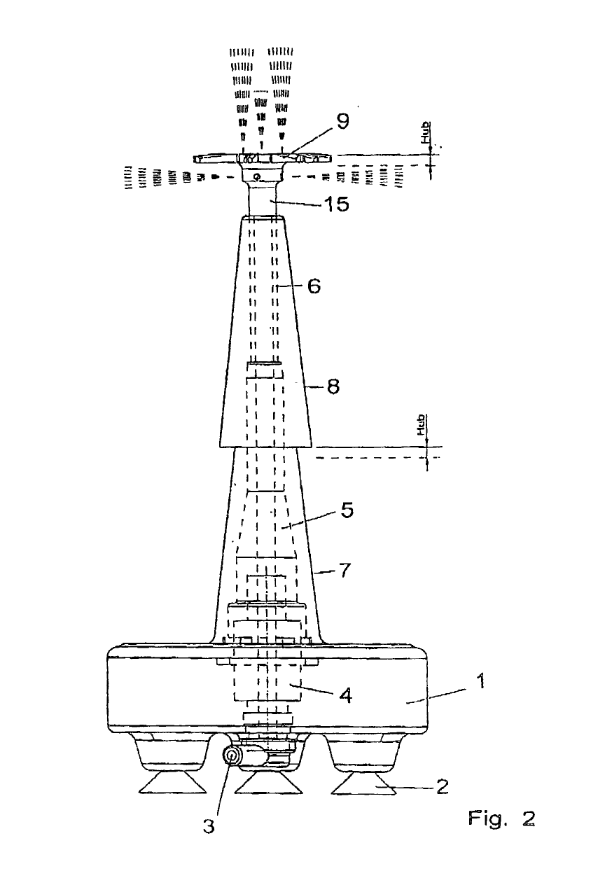

FIG. 2 illustrates the construction of the rinsing equipment and shows the emerging water jets for rinsing the mixing container and

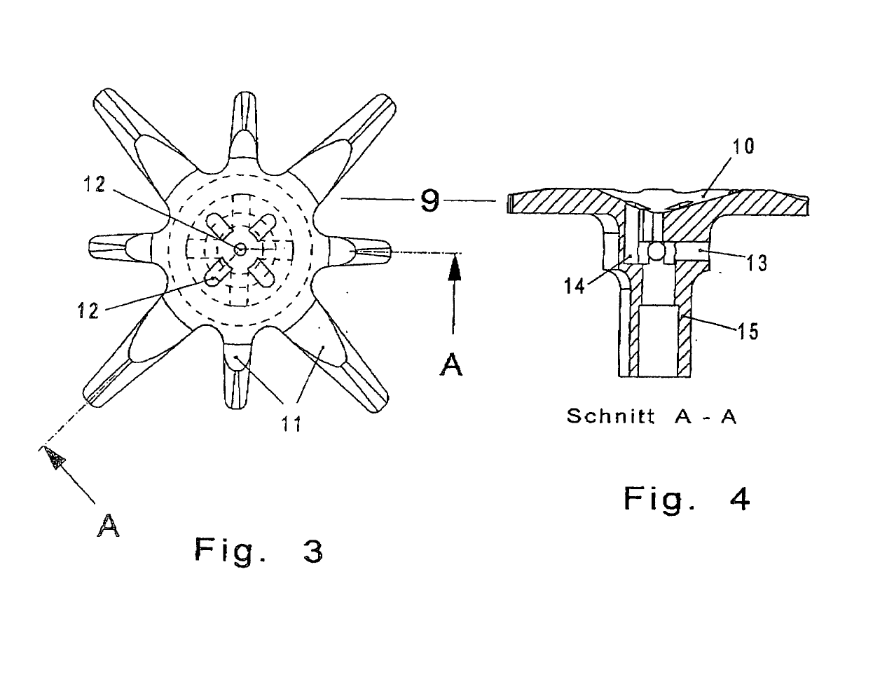

FIGS. 3+4 show the construction of an advantageous embodiment of the spraying plate (9).

The rinsing equipment of the invention, described here, comprises a socket housing (1) (FIG. 1), which rests with several suction cup holders (2), for example, on the bottom of the sink. In the socket housing, there is a pressure rinsing valve (4), which it opened by a lifting motion of the valve tube (6) and frees the path for the rinsing water. This was lifting motion is initiated by inverting and pressing down a vessel (mixing container, FIG. 1) on the spraying plate (9), the communicating piece (15) of which is fastened to the valve tube (6) in a known manner.

A guiding cylinder (5), in which the valve tube can move up and down, is disposed on the socket housing. The guiding cylinder is surrounded by an elastic, plastic glass protection (7), which is also cylindrical and prevents breakage of or damage to the vessels. Further towards the top, a second, elastic glass protection (8) is mounted, which has essentially the same function as the first one.

At the upper end of the valve tube (6), the star-shaped spraying plate (9) is fastened and, when depressed over the valve tube, opens the valve and, by these means, opens up the path for the rinsing water for spraying out the mixing container. The rinsing water sprays out of the spraying plate (9) (FIG. 2) in two directions. On the one hand, it sprays upward out of the nozzles (12) in the direction of the impact knife chamber of the mixing container. At the same time, the water jets also partly strike the inclined knives and, at the same time, are swirled, which produces an exceptional mixing action in this impact knife chamber and is of decisive importance for the desired rinsing result. On the other, it sprays horizontally out of the nozzles (13) for rinsing out the container wall. The water distribution chamber (14) assigns the rinsing water to nozzles (12) and (13).

It is an important prerequisite for the actuation of the valve that the spraying plate (9) is constructed so that the cap nut of the knife mechanism in the mixing container (FIG. 1) strikes the spraying plate (9) reliable and centrally. In this correction, the star-shaped cross members (11) initially guide the mixing container roughly and the trough-shaped depression (10) then ensures that this cap nut is captured centrally. This trough may be very flat and have any shape. These cross members (11) may be straight, as here, or also bent at right angles, curved or arc-shaped. The areas between the guiding cross members (11) provide sufficient space for those impact knives, which are directed not within the impact knife chamber but in the opposite direction.

The spraying plate (9) can also be used for any other rinsing units of a different construction.

The inventive spraying equipment represents an easily handled, advantageous and economic solution for rinsing containers, especially mixing containers. Due to the use of the inventive spraying plate (9), it is also possible to rinse containers having a complicated shape, especially mixing containers, efficiently with any rinsing units.

List of Reference Symbols

1. socket housing

2. suction cup holder

3. water connection

4. pressure spraying valve

5. guiding cylinder

6. valve tube

7. glass protection (bottom)

8. glass protection (top)

9. spraying plate

10. trough-shaped depression

11. guiding cross members

12. upwardly directed nozzles

13. horizontal nozzles

14. water distribution chamber

15. connecting piece

1. Rinsing equipment, especially for mixing containers, comprising a socket housing (1) with an interior pressure rinsing valve (4) and an upright valve tube (6), wherein a spraying plate (9) is seated on this valve tube (6).

2. The rinsing equipment of claim 1, wherein this spraying plate (9) has a trough-shaped depression (10).

3. The rinsing equipment of claims 1 or 2, wherein the spraying plate (9) runs out into star-shaped guiding cross members (11).

4. The spraying equipment of one of the claims 1 to 3, wherein there are several upwardly directed nozzles (12) at the spraying plate (9).

5. The rinsing equipment of one of the claims 1 to 4, wherein there are several horizontally directed nozzles (13) at the spraying plate (9).

6. The rinsing equipment of one of the claims 1 to 5, wherein the central part of the spraying plate (9) has a water distribution chamber (14).

7. A spraying plate (9) for any rinsing units, wherein this spraying plate (9) has a trough-shaped depression (10).

8. The spraying plate of claim 7, wherein this spraying plate (9) runs out into star-shaped cross members (11).

9. The spraying plate of claims 7 or 8 wherein there are several upwardly directed nozzles (12) at the spraying plate (9).

10. The spraying plate of one of the claims 7 to 9, wherein there are several horizontally directed nozzles (13) at the spraying plate (9).

11. The spraying plate of one of the claims 7 to 10, wherein the central part of the spraying plate (9) has a water distribution chamber (14).
